(19) United States
(12) Patent Application Publication
(10) Pub. No.: US 2026/0361602 A1
(43) Pub. Date: Nov. 12, 2026

(54) AUTOMATIC IMPLEMENTATION OF NETWORK FUNCTIONS IN A CELLULAR NETWORK

(71) Applicant: Boost SubscriberCo L.L.C., Englewood, CO (US)

(72) Inventors: Zeev Render, Ashburn, VA (US); Daejoong Kim, Reston, VA (US); Julio Armenta, Aldie, VA (US)

(21) Appl. No.: 19/204,292

(22) Filed: May 9, 2025

(51) Int. Cl. H04L 41/0894; H04L 41/08; H04L 41/082

(52) U.S. Cl. CPC H04L 41/0894; H04L 41/082; H04L 41/0886

(57) ABSTRACT

Techniques for implementation of network functions in a cellular network are provided. In one example, a cellular network includes: a radio unit that supports a cell of the network, a cluster of computing resources in communication with the radio unit that performs network functions in support of the radio unit, and a network management server system in communication with the cluster of computing resources. The server system includes a network service orchestrator that receives a trigger to modify a network function performed by the cluster, generates a configuration for the cluster including the modification to the network function, and submits the configuration to a repository. The server system further includes a reconciliation tool that determines that a difference exists between the configuration and a current configuration for the cluster and transmits the desired configuration to the cluster in response.

### BACKGROUND

There are many different applications that are deployed and managed in cellular networks. The same application can also have multiple instances. Some operations are quite complex, such as upgrading, rollback, and backup. For instance, an upgrade operation can be 60 or more commands that have to be run and verified manually, which is time consuming for network engineers. There is a large number of pre-checks, post-checks, and validations. Also, the commands for performing an operation for one application can be completely different from those of another application. Furthermore, the same application can have multiple versions in the network. For instance, different regions may run different versions of the application, and each version may have different upgrade procedures for the next release. Also, the upgrade process for a new release for one application can have a completely different process than that of another application. The human operator has to know how to perform all of the steps of the operation, pre-checks, post-checks, validations, etc. Accordingly, an improved and/or alternative approach to performing network operations may be beneficial.

### SUMMARY

Certain embodiments of the present disclosure may provide solutions to the problems and needs in the art that have not yet been fully identified, appreciated, or solved by current communications technologies, and/or provide a useful alternative thereto. For example, some embodiments of the present disclosure pertain to automatic implementation of operations for network applications via an orchestrator and software operators.

In some embodiments, a cellular network is provided. The cellular network may include a radio unit configured to support a cell of the cellular network. The cellular network may further include a cluster of computing resources in communication with the radio unit. The cluster of computing resources may be configured to perform a plurality of network functions that support operations of the radio unit. The cluster of computing resources may include an operator configured to modify at least one computing resource of the cluster of computing resources based on a specified configuration for the at least one computing resource. The cellular network may further include a network management server system in communication with the cluster of computing resources. The network management server system may include a network service orchestrator configured to: receive a trigger to modify a network function performed by the cluster of computing resources; generate, in response to receiving the trigger, a desired configuration for the cluster of computing resources that includes the modification to the network function; and submit the desired configuration for the cluster of computing resources to a configuration repository. The network management server system may further include a reconciliation tool configured to: determine that a difference exists between the desired configuration for the cluster of computing resources and a current configuration of the cluster of computing resources; and responsive to determining that the difference exists, transmit the desired configuration to the cluster of computing resources. In response to receiving the desired configuration, the operator may modify a computing resource that corresponds to the network function to be consistent with the desired configuration.

In some embodiments, the network management server system further comprises a policy engine configured to: transmit one or more policies for modifying the network function provided by the one or more computing resources to the network service orchestrator. In some embodiments, the desired configuration is generated based at least in part on the one or more policies received from the policy engine. In some embodiments, the one or more policies define at least one of a region in which the network function is to be modified and a time range during which the network function is to be modified. In some embodiments, the operator modifies the computing resource associated with the network function by at least one of: instantiating, terminating, configuring, reconfiguring, backing-up, recovering, upgrading, and rolling back the network function on the computing resource.

In some embodiments, the network management server system further includes a network function configuration database. The network service orchestrator may be further configured to: query the network function configuration database for configurations related to the network function in response to receiving the trigger; and receive, by the network service orchestrator, one or more configurations for the network function from the network function configuration database. In some embodiments, the desired configuration is generated based on at least one of the one or more configurations.

In some embodiments, the network management server system further comprises a network function requirements database. The network service orchestrator may be further configured to: query the network function requirements database for network function requirements related to the one or more computing resources; and receive one or more network function requirements for the one or more computing resources. In some embodiments, the desired configuration is generated based on at least one of the one or more network function requirements.

In some embodiments, the cluster is part of a container management system and comprises a control plane and a worker node configured to implement the network function. The control plane may comprise a network function controller that extends functionality of the container management system and manages the implementation of the network function by the worker node. The operator may modify the worker node configured to implement the network function by transmitting instructions for modifying the network function to the network function controller. The cluster may further include: a plurality of worker nodes comprising the worker node, each configured to implement a respective network function of a plurality of network functions provided by the cluster; and a respective operator for each of the plurality of network functions provided by the cluster.

In some embodiments, the network service orchestrator is further configured to: subscribe to a topic of a universal message bus; receive, via the topic of the universal message bus, results of modifying the computing resource from the operator; determine whether the network function provided by the one or more resources was successfully modified based on the results of modifying the computing resource; and update a network function status database with the results of modifying the network function in response to determining that the network function was successfully modified or transmitting a failure notification via a notification service in response to determining that the network function was unsuccessfully modified.

In some embodiments, a method of implementing network functions in a cellular network is provided. The method may include receiving, by a network service orchestrator, a trigger to modify a network function provided by one or more computing resources in the cellular network. The method may further include generating, by the network service orchestrator in response to receiving the trigger, a desired configuration for the one or more computing resources. The method may further include submitting, by the network service orchestrator, the desired configuration for the one or more computing resources to a configuration repository. The method may further include determining, by a reconciliation tool, that a difference exists between the desired configuration for the one or more computing resources and current configurations of the one or more computing resources. The method may further include, responsive to determining that the difference exists, transmitting, by the reconciliation tool, the desired configuration to an operator associated with the one or more computing resources, wherein in response to receiving the desired configuration, the operator modifies a computing resource of the one or more computing resources that is associated with the network function to be consistent with the desired configuration.

The method may further include transmitting, by the network service orchestrator, a verification request to a policy engine in response to receiving the trigger to modify the network function provided by the one or more computing resources in the cellular network; and receiving, by the network service orchestrator, and in response to the verification request, one or more policies for modifying the network function provided by the one or more computing resources from the policy engine. In some embodiments, the desired configuration is generated based at least in part on the one or more policies received from the policy engine. In some embodiments, the one or more policies for modifying the network function provided by the one or more computing resources define at least one of a region in which the network function is to be modified and a time range during which the network function is to be modified.

In some embodiments, the trigger to modify the network function is received from a pre-production environment, an Operation Support System (OSS), a Business Support System (BSS), an operations user, or an external automation trigger. In some embodiments, the operator modifies the computing resource associated with the network function by at least one of: instantiating, terminating, configuring, reconfiguring, backing-up, recovering, upgrading, and rolling back the network function on the computing resource.

The method may further include: querying, by the network service orchestrator, a network function configuration database for configurations related to the network function; and receiving, by the network service orchestrator, one or more configurations for the network function from the network function configuration database. In some embodiments, the desired configuration is generated based on at least one of the one or more configurations.

The method may further include: querying, by the network service orchestrator, a network function requirements database for network function requirements related to the one or more computing resources; and receiving, by the network service orchestrator, one or more network function requirements for the one or more computing resources. In some embodiments, the desired configuration is generated based on at least one of the one or more network function requirements.

In some embodiments, the one or more computing resources are part of a cluster of a container management system. The cluster may comprise a control plane and a worker node configured to implement the network function. The control plane may comprise a network function controller that extends functionality of the container management system and manages the implementation of the network function by the worker node. The operator may modify the worker node configured to implement the network function by transmitting instructions for modifying the network function to the network function controller. The cluster may further comprise: a plurality of worker nodes comprising the worker node, each configured to implement a respective network function of a plurality of network functions provided by the cluster; and a respective operator for each of the plurality of network functions provided by the cluster.

The method may further include: subscribing, by the network service orchestrator, to a topic of a universal message bus; receiving, by the network service orchestrator via the topic of the universal message bus, results of modifying the computing resource from the operator; determining, by the network service orchestrator, whether the network function provided by the one or more resources was successfully modified based on the results of modifying the computing resource; and updating, by the network service orchestrator, a network function status database with the results of modifying the network function in response to determining that the network function was successfully modified or transmitting a failure notification via a notification service in response to determining that the network function was not unsuccessfully modified.

In some embodiments, a system is provided. The system may include: one or more processors; and a computer-readable medium comprising instructions. When executed by the one or more processors, the instructions may cause the system to receive, by a network service orchestrator, a trigger to modify a network function provided by one or more computing resources in a cellular network. The instructions may further cause the system to generate, by the network service orchestrator in response to receiving the trigger, a desired configuration for the one or more computing resources. The instructions may further cause the system to submit, by the network service orchestrator, the desired configuration for the one or more computing resources to a configuration repository. The instructions may further cause the system to determine, by a reconciliation tool, that a difference exists between the desired configuration for the one or more computing resources and current configurations of the one or more computing resources. The instructions may further cause the system to, responsive to determining that the difference exists, transmit, by the reconciliation tool, the desired configuration to an operator associated with the one or more computing resources, wherein in response to receiving the desired configuration, the operator modifies a computing resource of the one or more computing resources that is associated with the network function to be consistent with the desired configuration.

### BRIEF DESCRIPTION OF THE DRAWINGS

In order that the advantages of certain embodiments of the disclosure will be readily understood, a more particular description of the disclosure briefly described above will be rendered by reference to specific embodiments that are illustrated in the appended drawings. While it should be understood that these drawings depict only typical embodiments of the disclosure and are not therefore to be considered to be limiting of its scope, the disclosure will be described and explained with additional specificity and detail through the use of the accompanying drawings, in which:

FIG. 1 is an architectural diagram illustrating a Kubernetes® cluster, according to an embodiment of the present disclosure.

FIG. 2 is an embodiment of a cellular network system, according to an embodiment of the present disclosure.

FIG. 3 is an architectural diagram illustrating a network management system, according to an embodiment of the present disclosure.

FIG. 4 is a flow diagram illustrating a process for scheduling an operation from an external event trigger, according to an embodiment of the present disclosure.

FIG. 5 is an architectural diagram illustrating a telecommunications system that implements software operators for automatic implementation of operations for network applications, according to an embodiment of the present disclosure.

FIG. 6 is a flow diagram illustrating a process for performing operations in a network using an SMO and an operator, according to an embodiment of the present disclosure.

FIG. 7 is an architectural diagram illustrating a computing system configured to participate in a process for performing operations in a network using an SMO and an operator, according to an embodiment of the present disclosure.

FIG. 8 is a flowchart illustrating a process for performing operations in a network using an SMO and an operator, according to an embodiment of the present disclosure.

Unless otherwise indicated, similar reference characters denote corresponding features consistently throughout the attached drawings.

### DETAILED DESCRIPTION

Some embodiments of the present disclosure pertain to automatic implementation of operations for network applications via an orchestrator and software operators. Per the above, current software operations in a telecommunications network (e.g., instantiation, upgrade, configuration, reconfiguration, backup, rollback, recovery, termination, etc.) are manual, involve many steps, are time consuming, and are subject to human error. Furthermore, different versions of software applications may need to be applied to different regions in the network.

Accordingly, some embodiments of the present disclosure allow a software orchestrator to automatically perform various operations for these applications via software operators. As used herein, “software operator(s)” should be understood to be any type of software operator that utilizes custom resources to manage applications and/or components. In one embodiment, the type of software operator may be a Kubernetes® operator. The software operators, which may be provided by the NF vendor (e.g., the carrier itself or a third party) since they have the domain knowledge. In other words, since they developed these applications, they may be most knowledgeable regarding how to develop the operators so the operations can be automated. Operators may be provided on a per-NF basis in some embodiments. However, in other embodiments, a single operator may handle operations for multiple NFs in at least some cases.

Using the example of an NF upgrade operation, the commands for the upgrade are run sequentially and the next steps are triggered based on the output of the previous command (i.e., the previous step). For instance, for some NF upgrade operations, the steps include stopping an NF database, migrating the NF database to a new schema, updating the NF itself to the new version, etc. The steps that are performed will depend on the characteristics of the application and the nature of the operation. Using software operators speeds up the process of performing the operation and may increase accuracy over the current manual processes. This also frees up human operators to perform other tasks.

A NF controller is provided for the operator in the master node(s) of the cluster. The operator makes Application Programming Interface (API) calls for the NF controller via an API gateway (GW). When the operator begins performing an operation, the operator contacts the NF controller via the API GW with instructions to perform the first step of the operation. The network controller performs this step and informs the operator of the progress (e.g., the result of the step) via the API GW. The operator then publishes the status pertaining to the execution progress and the results to a universal message bus via a predefined topic pertaining to the operation. This process is repeated for the steps of the operation. The orchestrator is subscribed to this topic, and thus, is apprised of the progress throughout the operation. The orchestrator is also informed if the operation fails for some reason.

The software operator extends the behavior of a container orchestration system such as Kubernetes® without modifying the code thereof. As such, the operator is an additional component that is added to the cluster. The operator provides NF-specific automation for its respective NF. In other words, the operator contains logic to implement each operation that the orchestrator may request. The operator may automate deep, human-like knowledge in a particular domain and provide an automated framework for execution of repeatable tasks by embedding the required domain knowledge into code.

The container orchestration system facilitates automation of application deployment, management, and scaling. In the case of Kubernetes®, NF containers run inside objects called pods. Kubernetes® runs workloads by placing containers into pods to run on nodes. A node may be a virtual machine or a physical machine (e.g., a server with processors, memory, etc.), depending on the cluster design. Each node is managed by the control plane and contains the services necessary to run the pods. Typically, multiple nodes are included in a cluster.

A pod is the smallest and simplest Kubernetes® object, representing one or more running containers on a cluster that have shared storage and network resources, as well as a specification for how to run the containers. The contents of a pod are co-located and co-scheduled, as well as run in a shared context. A pod models an application-specific “logical host”. It contains one or more application containers that are relatively tightly coupled. In non-cloud contexts, applications executed on the same physical or virtual machine are analogous to cloud applications executed on the same logical host. An example of a pod that consists of a container running the image DISH: 1.1.1 is provided below.
apiVersion: v1
kind: Pod
metadata:
   name: DISH
spec:
   containers:
      name: DISH
         image: DISH: 1.1.1
         ports:
         containerport: 80

The control plane is the container orchestration layer that exposes the API to define, deploy, and manage the lifecycle of containers. Master nodes run the control planes, and each cluster may have one or more master nodes. A container is a lightweight and portable executable image that contains software and all of its dependencies.

The Service Management Orchestrator (SMO), also called the “orchestrator” herein, is the highest entity in the telecommunications network in some embodiments and hovers over physical devices (e.g., Radio Access Network (RAN) computing systems, computing systems of the core network, etc.), communicates with databases, and implements policies from a policy engine. The SMO may drive interoperability and vendor neutrality through the use of standardized interfaces and virtualization technologies in some embodiments. For instance, for an NF that does not affect the network much when upgraded or that is not used very frequently, a policy may dictate that an upgrade operation for an NF should be performed at any time other than the highest typical congestion periods for the network. However, for a critical NF that will heavily affect network performance during the upgrade operation (e.g., one that would severely limit the number of users that the network can handle), the policy may be more strict, such as only upgrading on Saturdays between 2:00 am and 6:00 am when network usage tends to be very light.

The SMO is an intelligent entity that communicates with a pre-production environment, the policy engine, internal systems (e.g., an application configuration database and an application custom requirements database), and external systems (i.e., those systems provided and managed by third parties external to the network operator). The SMO builds API commands or calls (e.g., in the form of a file) and sends them downstream to a repository. The file may be a JavaScript Object Notation (JSON) file, an Extensible Application Markup Language (XAML), or any other suitable format without deviating from the scope of the disclosure. The API call has everything that is needed to perform the operation for the NF, such as instantiation, upgrade, configuration, reconfiguration, backup, rollback, recovery, termination, etc. The NF may be a cloud-native NF (CNF) in some embodiments. The repository stores the configuration file responsive to the call from the SMO.

Consider the case where the SMO is seeking to perform a backup operation for all NFs in an area (e.g., the city of Los Angeles). The SMO can query for all of the site identifiers (IDs) for the area and send an API command for each cluster in the area that will trigger the backup operation for each cluster. In other words, the SMO knows what to query from the various internal and external systems for the given operation to create the API call. The software operator knows how to perform the backup operation and does so upon receiving a request to do so.

The SMO can determine what release of a given application should be applied, what clusters to apply it to, the nodes in the clusters, the cluster configurations, etc. If an application needs to be reconfigured, the SMO can obtain the parameters and push the reconfiguration downstream via an API call with the new parameters. The SMO may manage operations for applications that reside in RAN computing systems (e.g., base stations), as well as in computing systems of the core network. The SMO and the applications can reside in the same data center (e.g., a National Data Center (NDC), a Regional Data Center (RDC), or a Breakout Edge Data Center (BEDC)) or different data centers. There may be multiple SMOs in the network in some embodiments. In an Open RAN (O-RAN) architecture, the applications may run on Distributed Units (DUs), Centralized Units (CUs), other RAN computing systems, computing systems of the core network, etc.

The repository (e.g., a Git) is a “single source of truth” that stores the desired state of the application versions and their configuration, as well as images in the case of CNFs (e.g., docker images). Once the SMO pushes a file via an API, the repository stores the configuration, and a continuous delivery (CD) and reconciliation tool (e.g., Argo CD for Kubernetes®, which is implemented as a Kubernetes® controller) retrieves the file, compares the configuration to the state of the respective cluster(s) that the configuration applies to, and determines that the configuration and the state of these cluster(s) do not match. In other words, the CD and reconciliation tool monitors the repository and compares the “desired configurations” located therein to those of “managed resources” (i.e., the currently deployed applications, the clusters, etc.). When the CD and reconciliation tool identifies a difference, it will impose the desired configuration on the respective managed resources, thus eliminating the difference therebetween. A deployed application whose live state deviates from the target state is considered to be out of sync, and the CD and reconciliation tool causes the software operator to automatically sync the live state of the application back to the desired target state using the configuration from the SMO. In other words, the CD and reconciliation tool compares what is in the repository to what is in the cluster, or in the case that no such cluster exists, implements a new cluster with the configuration in the repository.

Consider the case that a configuration file in the repository pertains to a new version of an NF running in a cluster. When the configuration file for the new release is pushed to the repository by the SMO, the CD and reconciliation tool determines that the version of the NF running in the cluster does not match that of the configuration file. The CD and reconciliation tool then makes an API call to an API gateway (GW) of the respective cluster to cause the respective software operator therein to perform the associated operation.

Using the parameters in the configuration file, the CD and reconciliation tool can determine which cluster(s) an upgrade pertains to, for example, so different versions of the application can be applied to different clusters depending on their architecture. The SMO and the CD and reconciliation tool do not need to know how to perform the operation for the specific application and/or cluster. Rather, the CD and reconciliation tool triggers the operation via the software operator(s) with the cluster ID(s) and the required parameters.

With respect to provisioning a new cluster, the nodes thereof can be provided by a managed virtual service where the network operator indicates how many nodes are desired, how many should be implemented as physical machines versus virtual machines, or both. For instance, in the managed virtual service scenario, consider the case where an application in a cluster requires five nodes of a certain type with 4 Central Processing Units (CPUs) and 10 gigabytes (GB) of memory. These requirements can be pushed to the repository in a configuration file, and the CD and reconciliation tool will cause the cluster to be deployed with these specifications. More specifically, the CD and reconciliation tool triggers a tool to provision and manage cloud infrastructure (e.g., Crossplane for Kubernetes®). This tool then provisions the cluster according to the configuration requirements. Subsequent operations pertaining to applications are implemented via the respective software operators.

When there are multiple versions of a release, in some embodiments, the SMO may query the policy engine to determine to which cluster(s) each version should be deployed and when. The SMO then causes the upgrade operation for each version/region to be performed by the appropriate operator(s) of the appropriate cluster(s). In this manner, multiple versions of a release may be managed and rolled out to the appropriate locations and systems.

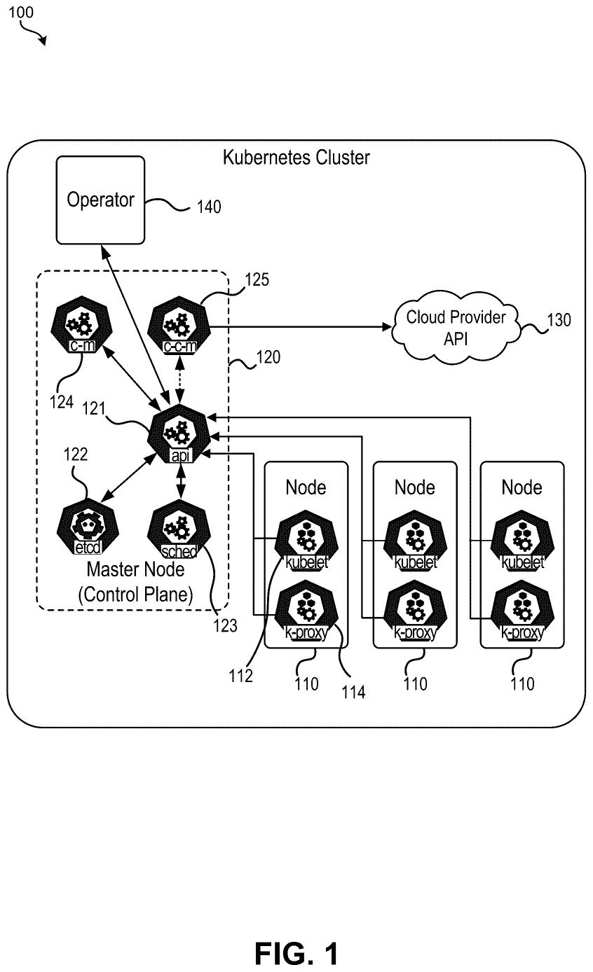

FIG. 1 is an architectural diagram illustrating a Kubernetes® cluster 100, according to an embodiment of the present disclosure. A Kubernetes® cluster consists of a set of worker machines (nodes) that run containerized applications. Each cluster has at least one worker node. In this case, Kubernetes® cluster 100 has three worker nodes 110, each of which communicates with APIs 121 of a master node 120 that includes a control plane.

Worker nodes 110 host the pods, which are the components of the application workload. The pods may implement respective NFs, for instance. A control plane 120 manages worker nodes 110 and their respective pods in cluster 100. In production environments, control plane 120 usually runs across multiple computers and the cluster typically includes multiple nodes, providing fault-tolerance and high availability.

The components of control plane 120 perform global decisions about cluster 100, such as scheduling, as well as detecting and responding to cluster events (e.g., starting up a new pod when a replicas field of a deployment is unsatisfied). Components of control plane 120 can be run on any machine in cluster 100. However, for simplicity, setup scripts typically start all components of the control plane on the same machine, and do not run user containers on this machine.

The API server of control plane 120 exposes Kubernetes® API 121. The API server is the front end for the control plane 120, allowing other components to communicate with control plane 120. The main implementation of a Kubernetes® API server is kube-apiserver, which is designed to scale horizontally by deploying more instances. Multiple instances of kube-apiserver can be run and traffic can be balanced between those instances. An open-source distributed key-value store (etcd) 122 is used to hold and manage the critical information that distributed systems use to keep running. This is used as the backing store for all cluster data.

The kube-scheduler (sched) 123 of control plane 120 watches for newly created pods with no assigned node and selects a node for these new pods to run on. Factors taken into account for scheduling decisions include individual and collective resource requirements, hardware/software/policy constraints, affinity and anti-affinity specifications, data locality, inter-workload interference, and deadlines. The kube-controller-manager (c-m) 124 is the component of control plane 120 that runs controller processes. Logically, each controller is a separate process, but to reduce complexity, they may all be compiled into a single binary and run in a single process. There are many different types of controllers, such as node controllers responsible for noticing and responding when nodes go down, job controllers that watch for job objects that represent one-off tasks and then create pods to run these tasks to completion, EndpointSlice controllers that populate EndpointSlice objects to provide a link between services and pods, and ServiceAccount controllers that create default ServiceAccounts for new namespaces.

Custom controllers, as described further herein, can be created for tasks that are not natively available in Kubernetes®. An operator 140 can use custom controllers of kube-controller-manager 124 to perform such tasks on a corresponding worker node. Operator 140 communicates with the custom controller in kube-controller-manager 124, and vice versa, via APIs 121. The custom controller also communicates with worker nodes 110 via APIs 121 if required by the task.

A cloud-controller-manager (c-c-m) 125 is a component of the control plane 120 that embeds cloud-specific control logic. Cloud controller manager 125 lets users link clusters into a cloud provider API 130 and separates out the components that interact with that cloud platform from components that only interact with cluster 100. Cloud-controller-manager 125 runs controllers that are specific to the cloud provider. If Kubernetes® is located on a user's own premises or in a learning environment inside a personal computer (PC), the cluster does not typically have a cloud controller manager.

As with kube-controller-manager 124, cloud-controller-manager 125 combines several logically independent control loops into a single binary that runs as a single process. Cloud-controller-manager 125 can scale horizontally (i.e., run more than one copy) to improve performance or to help tolerate failures. Node controllers, route controllers, and service controllers can have cloud provider dependencies.

Node components run on each of nodes 110, maintaining running pods and providing the Kubernetes® runtime environment. Kubelets 112 are agents that runs on nodes 110 in cluster 100. Kubelets 112 makes sure that containers are running in a pod. Kubelets 112 take a set of PodSpecs that are provided through various mechanisms and ensures that the containers described in those PodSpecs are running and healthy. The kubelet service is an agent that allows the respective worker nodes to communicate with the API server on the master node and sets up pod requirements, such as mounting volumes, starting containers, and reporting status. Kubelets 112 do not manage containers that were not created by Kubernetes®.

A kube-proxy (k-proxy) 114 is a network proxy that runs on each of nodes 110 in cluster 100. Kube-proxy 114 maintains network rules on nodes. These network rules allow network communication to pods from network sessions inside or outside of cluster 100. Kube-proxy 114 uses the operating system packet filtering layer if there is one and it is available. Otherwise, kube-proxy 114 forwards the traffic itself.

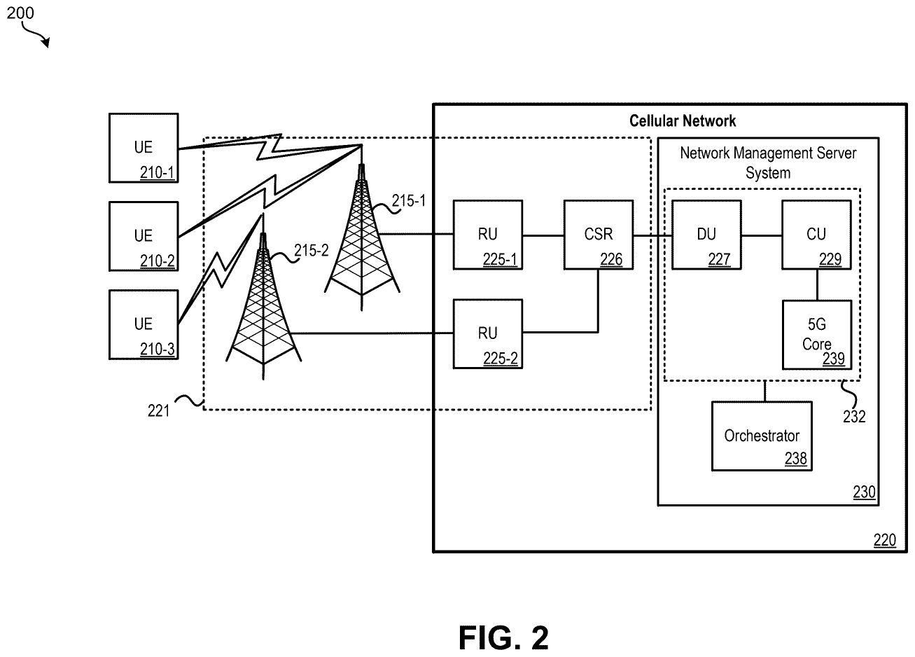

FIG. 2 illustrates an embodiment of a cellular network system 200 (“system 200”). System 200 can include a 5G New Radio (NR) cellular network; other types of cellular networks, such as 6G, 7G, etc., may also be possible. System 200 can include: UE 210 (UE 210-1, UE 210-2, UE 210-3); antennas 215; cellular network 220; radio units 225 (“RUs 225”); cell site router 226 (“CSR 226”); DU 227; centralized unit 229 (“CU 229”); 5G core 239, and orchestrator 238. FIG. 2 represents a component-level view. In an open radio access network (O-RAN), because components can be implemented as specialized software executed on general-purpose hardware, except for components that need to receive and transmit Radio Frequency (RF) signals, the functionality of the various components can be shifted among different servers. For at least some components, the hardware may be maintained by a separate cloud-service provider, to accommodate where the functionality of such components is needed, or a hybrid arrangement which can use an on-premises data center and cloud computing functionality.

UE 210 can represent various types of end-user devices, such as cellular phones, smartphones, cellular modems, cellular-enabled computerized devices, sensor devices, gaming devices, access points (APs), any computerized device capable of communicating via a cellular network, Internet of Things (IoT), etc. Generally, UE can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, UE 210 may use RF to communicate with various base stations (BSs) of cellular network 220, such as BS 221. BS 221 can include: antennas 215, RUs 225, and CSR 226. Antennas 215 may be mounted to a physical structure, such as a dedicated cellular tower, a building, a water tower, or any other man-made or natural structure to which one or more antennas can reasonably be mounted to provide cellular coverage to a geographic area.

Real-world implementations of system 200 can include many (e.g., thousands) of BSs and many CUs and 5G core 239. Antennas 215 may allow RUs 225 to communicate wirelessly with UEs 210. RUs 225 can represent an edge of cellular network 220 where data is transitioned to RF for wireless communication. The radio access technology (RAT) used by RU 225 may be 5G New Radio (NR), or some other RAT. The remainder of cellular network 220 may be based on an exclusive 5G architecture, a hybrid 4G/5G architecture, a 4G architecture, or some other cellular network architecture.

One or more RUs, such as RUs 225, may communicate with DU 227 via one or more routers, such as CSR 226. As an example, at a possible cell site, three RUs may be present, each connected with the same DU. A single DU may further be connected to RUs at multiple cell sites or BSs. Different RUs may be present for different portions of the spectrum and/or different cells provided by a BS. For instance, a first RU may operate on the spectrum in the citizens broadcast radio service (CBRS) band while a second RU may operate on a separate portion of the spectrum, such as, for example, band 71. In some embodiments, an RU can also operate on three bands. One or more DUs, such as DU 227, may communicate with CU 229. Collectively, an RU, DU, and CU create a gNodeB, which serves as the radio access network (RAN) of cellular network 220. DU 227 and CU 229 can communicate with 5G core 239. The specific architecture of cellular network 220 can vary by embodiment. Edge cloud server systems outside of cellular network 220 may communicate, either directly, via the Internet, or via some other network, with components of cellular network 220. For example, DU 227 may be able to communicate with an edge cloud server system without routing data through CU 229 or 5G core 239. Other DUs may or may not have this capability.

While FIG. 2 illustrates various components of cellular network 220, other embodiments of cellular network 220 can vary the arrangement, communication paths, and specific components of cellular network 220. While RUs 225 may include specialized radio access componentry to enable wireless communication with UE 210, other components of cellular network 220 may be implemented using either specialized hardware, specialized firmware, and/or specialized software executed on a general-purpose server system. In an O-RAN arrangement, specialized software on general-purpose hardware may be used to perform the functions of components such as DU 227, CU 229, and 5G core 239. As such, functionality of components such as DUs and CUs can be co-located or distributed across disparate physical server systems. For example, certain components of 5G core 239 may be co-located with components of CU 229.

As illustrated, DU 227, CU 229, 5G core 239, and orchestrator 238 may be executed by network management server system 230. As described further herein, network management server system 230 may include one or more physical and/or virtual machines configured to execute some or all of the functions of DU 227, CU 229, 5G core 239, and orchestrator 238. For example, network management server system 230 may include a cluster of one or more physical servers. Specialized software that performs the logical functions of one or more DUs, such as DU 227, may be executed directly by the operating system of the one or more physical servers. Additionally, or alternatively, a cluster of one or more virtual machines may be instantiated across the cluster of one or more physical servers. The specialized software that performs the logical functions of the one or more DUs may then be installed within, and executed by, the virtual machines.

In a possible O-RAN implementation, DU 227, CU 229, 5G core 239, and/or orchestrator 238 can be implemented virtually as software being executed by general-purpose computing equipment, such as in a data center, as detailed herein. Therefore, depending on needs, the functionality of a DU, CU, and/or 5G core may be implemented locally to each other and/or specific functions of any given component can be performed by physically separated server systems (e.g., at different server farms). For example, the physical machines of network management server system 230 may be located at or near the one or more BSs for which they are intended to support, such as BS 221. In some embodiments, the distance is selected to ensure that the transmission time between the DU server system and any of the BSs for which it is intended to provide DU functionalities meets minimum latency requirements. As another example, some functions of a CU may be located at a same server facility as network management server system 230, while other functions are executed at a separate server system or on a public or private cloud computing system.

In the illustrated embodiment of system 200, network components 232 include DU 227, CU 229 and 5G core 239. Such network components 232 may be executed as specialized software executed by underlying general-purpose computer servers. Network components 228 may be executed on a third-party cloud-based computing platform or a cloud-based computing platform operated by the same entity that operates the RAN. A cloud-based computing platform may have the ability to devote additional hardware resources to network components 232 or implement additional instances of such components when requested.

Kubernetes®, Docker®, or a similar container orchestration platform, can be used to create and destroy the logical DU, CU or 5G core units and subunits as needed for the cellular network 220 to function properly. Kubernetes® allows for container deployment, scaling, and management. As an example, if cellular traffic increases substantially in a region, an additional logical CU or components of a CU may be deployed in a data center near where the traffic is occurring without any new hardware being deployed. Rather, processing and storage capabilities of the data center would be devoted to the needed functions. When the need for the logical CU or subcomponents of the CU no longer exists, Kubernetes® can allow for removal of the logical CU. In addition to scalability, Kubernetes® can also be used for failure management of various components of cellular network 220, as described further herein. Kubernetes® can also be used to control the flow of data (e.g., messages) and inject a flow of data to various components. This arrangement can allow for the modification of nominal behavior of various layers.

The deployment, scaling, and management of such virtualized components can be managed by orchestrator 238. Orchestrator 238 can represent various software processes executed by underlying computer hardware. Orchestrator 238 can monitor cellular network 220 and determine the amount and location at which cellular network functions should be deployed to meet or attempt to meet service level agreements (SLAs) across slices of the cellular network. Additionally, or alternatively, orchestrator 238 can provision physical and/or virtual resources in response to increased demands or failing components.

Orchestrator 238 can allow for the instantiation of new components of cellular network 220. As an example, to instantiate a new core function, a backup function, or the like, orchestrator 238 can perform a pipeline of calling the core function code from a software repository incorporated as part of, or separate from, cellular network 220; pulling corresponding configuration files (e.g., helm charts); and initiating implementation of the new core function by the appropriate clusters/nodes/pods in network components 232, as described further herein.

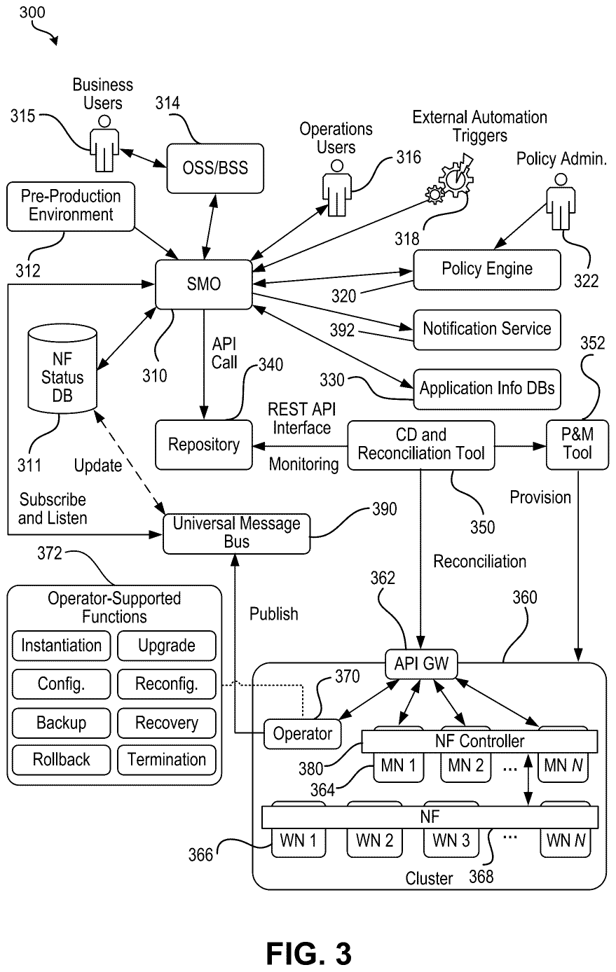

FIG. 3 is an architectural diagram illustrating a network management system 300, according to an embodiment of the present disclosure. Network management system 300 may be the same, or function in a similar manner, as network management server system 230 described above. An SMO 310 interacts with various entities, including a pre-production environment 312, an Operation Support System (OSS) and Business Support System (BSS) 314 of a Mobile Network Operator (MNO) or Mobile Virtual Network Operator (MVNO) operated by business users 315, operations users 316 (e.g., network engineers), and external automation triggers 318.

Pre-production environment 312 is where new application releases are tested. Pre-production environment 312 can inform SMO 310 that for a certain application (e.g., an NF), a new release is ready. SMO 310 can then check with a policy engine 320 for applicable policies defined for new releases, which may govern the regions the new release will be applied to and at what date and time. SMO 310 can then initiate the update accordingly by pushing the configuration to a repository 340. In other words, SMO 310 can be controlled to perform the update after the new release has been tested and is ready for operation in the live network. Alternatively, SMO 310 may query policy engine 320 automatically, build the API call, and cause the operation to be performed.

Policies may be created and modified by a policy administrator 322 in accordance with the policy goals of the MNO or MVNO. Policies created and modified by a policy administrator 322 may include cloud deployment policies, upgrade scheduling policies, or the like. Policy goals for cloud deployment policies may include reducing the overall cost associated with application deployments by deploying applications in regions with lower cloud service costs, increasing application availability by deploying applications in regions with redundancy, or the like. Policy goals for upgrade scheduling policies may include reducing the impact of application upgrades by scheduling upgrades for high impact applications during times of the day and/or week when network traffic is typically at a reduced level compared to peak traffic times. Policies may include one or more rules that govern when and/or how SMO 310 initiates operations in response to a trigger, thereby ensuring that the operation is performed in accordance with the associated policy goals of the policy. In some embodiments, one or more policies, and the one or more associated rules of each policy, are defined for corresponding operations initiated by SMO 310 in response to a trigger.

Triggers to cause SMO 310 to initiate an operation can also come from other sources, such as OSS/BSS 314, operations users 316, and external automation triggers 318. In OSS/BSS 314, the BSS has integration tools (e.g., a Customer Relationship Management (CRM) system, provisioning system, billing system, order management system, etc.) The OSS performs fault, configuration, audit, performance, and security (FCAPS) functions. In other words, the OSS is towards the network side of the carrier and the BSS is towards the business side of the carrier. External automation triggers 318 may come from a script, a ticketing system, or any other external application trigger without deviating from the scope of the disclosure. Some example triggering applications include, but are not limited to, ServiceNow®, Jira®, etc.

Requests to perform the operation from OSS/BSS 314 or operations users 316, and external automation triggers 318 from external event requirements, are received by SMO 310 and passed to policy engine 320. In response thereto, policy engine 320 may trigger SMO 310 to initiate the operation in accordance with one or more policies defined for the requested operation. Internal requirements, such as scheduled triggers, may be triggered by policy engine 320 to cause SMO 310 to perform the appropriate operation(s) on the appropriate system(s) at the desired time. Additionally, or alternatively, in response to receiving the request from SMO 310, policy engine 320 may identify the applicably policies and return them to SMO 310 for interpretation and/or execution.

When SMO 310 receives a request from one of these sources, SMO 310 translates the request into the actual configuration for the requested operation (e.g., a configuration file to update a cluster). In other words, SMO 310 implements policies from policy engine 320. For example, when a new update for an application is available, policy engine 320 may include upgrade instructions (e.g., date and time of upgrade). This way, SMO 310 may communicate with policy engine 320 to determine when to execute or implement upgrades to an application. SMO 310 also queries application information databases 330 for information pertaining to applications. Databases 330 may include an application configuration database that stores application configurations for new releases. Databases 330 may also include an application custom requirements database that stores custom requirements that certain nodes need to have, and may include specific patches, specific interface configurations, etc.

When an operation should be performed, whether at the manual request of a human user or based on external automation trigger 318, SMO 310 obtains the policy from policy engine 320, obtains the application configuration and custom application requirements (if these are applicable to the operation) from databases 330, and generates a configuration file for an API request for the operation. This may occur in real time or near-real time in some embodiments. SMO 310 then makes an API call that pushes the configuration to a repository 340 in accordance with the policy. A CD and reconciliation tool 350 determines via a Representational State Transfer (REST) API interface that the configuration does not match the configuration of a cluster 360, retrieves the configuration, and initiates a reconciliation process with an API 362 of cluster 360.

The configuration includes the information regarding the operation that is to be performed. However, CD and reconciliation tool 350 itself does not know what operation is to be performed. Instead, CD and reconciliation tool 350 compares the configuration file in the repository to the state of the cluster. In other words, without changes by SMO 310, the information contained in repository 340 and the state of cluster 360 are the same. When SMO 310 pushes changes to the repository, CD and reconciliation tool 350 determines that there is a difference between the configuration in the repository and that of cluster 360, and CD and reconciliation tool 350 pushes the new configuration to cluster 360 through API GW 362.

API GW 362 is an exposed endpoint (e.g., a Hypertext Transfer Protocol (HTTP) endpoint) of the container orchestration system for cluster 360 that allows external applications to read and write the state of the objects in the container orchestration system. Cluster includes N master nodes 364 and N worker nodes 366. Worker nodes 366 run the pods that implement the NFs.

It should be noted that some operations facilitated by SMO 310 and CD and reconciliation tool 350 pertain to creating the clusters themselves. For such operations, CD and reconciliation tool 350 triggers a provisioning and management tool 352 that provisions and manages cloud infrastructure. Provisioning and management tool 352 then provisions cluster 360 according to the configuration requirements.

When CD and reconciliation tool 350 requests reconciliation from API GW 362 based on the configuration from SMO 310, an operator 370 for the NF determines which operator-supported function 372 applies. For instance, the reconciliation request may pertain to NF instantiation, NF termination, NF configuration, NF re-configuration, NF backup, NF recovery, NF upgrade, NF rollback, etc. It should be noted that while one operator 370 is shown in this example, each NF may have its own operator in some embodiments.

Operator 370 compares the configuration to the current state of cluster 360 and imposes the changes on the cluster by making API calls to API GW 362 to perform the steps of the operation associated with the configuration from SMO 310. API GW 362, in turn, routes the information in the API calls (e.g., instructions to perform steps of the operation, along with required configuration data) to NF controller 380. NF controller 380 is a custom controller that resides within the control plane of master nodes 364 that extends the functionality in the container management system. NF controller 380 also deploys and manages NFs 368 on worker nodes 366. By instructing NF controller 380 to perform the steps of the operation, operator 370 causes NF controller 380 (if the operation is successful) to bring the actual state of cluster 360 to the desired state, as expressed in the configuration. While illustrated as being separate from worker nodes 366, operator 370 may exist in one of worker nodes 366, and/or be implemented as a separate worker node, in order manage one or more NFs.

During the execution of the operation, operator 370 publishes the execution progress and results to a universal message bus 390 (e.g., Apache Kafka®) via predefined topic pertaining to the operation. SMO 310 is subscribed to this topic and other predefined topics, and will listen for and receive updates related to the execution via an automated feedback loop. Upon successful completion of the operation, SMO 310 updates an NF status database 311, thus providing a closed-loop automation. NF status database 311 stores the current cluster configurations, their NFs, the NF versions, the NF configurations, etc. NF status database 311 also allows SMO 310 to compare the current version of the NF to that in the trigger from pre-production environment 312, OSS/BSS 314, operations user 316, external automation trigger 318, policy engine 320, etc. In some embodiments, universal message bus 390 itself updates NF status database 311.

However, if the operation fails, SMO 310 automatically sends details pertaining to the failed execution (e.g., error logs, cluster status information, etc.) to a notification service 392. Notification service 392 may notify human operators, vendor engineers, etc. The notified personnel and/or systems can then determine the remedial action that should be taken.

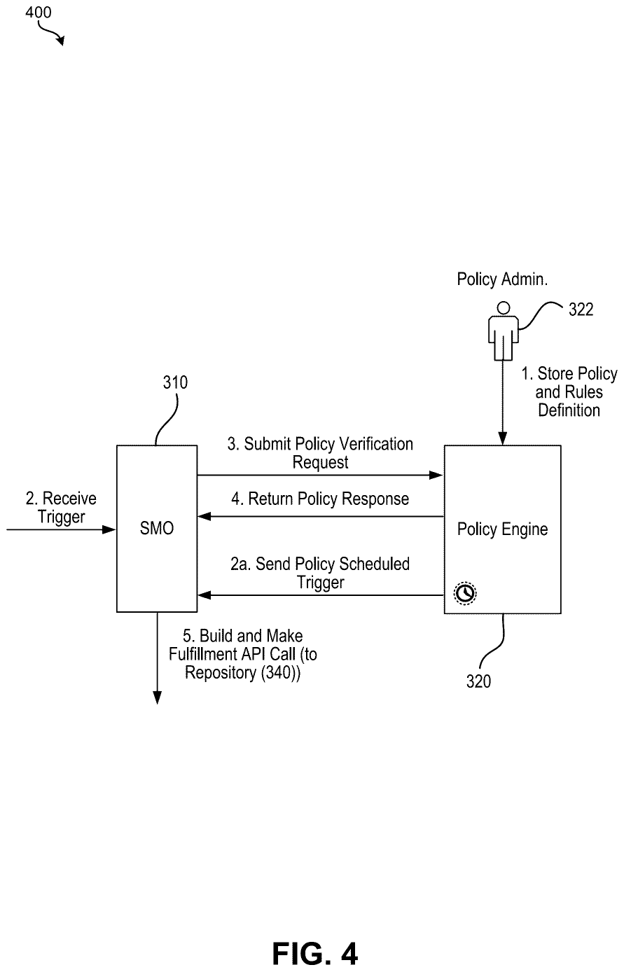

FIG. 4 is a flow diagram illustrating a process 400 for scheduling an operation from external event trigger 318, according to an embodiment of the present disclosure. Policy admin 322 creates a policy and rules definition for the respective operation and submits (1) it to policy engine 320. SMO 310 then receives (2) a trigger. The trigger may come from pre-production environment 312, OSS/BSS 314, or a business user 316, or be an external automation trigger 318, for example. The trigger may include instructions for upgrading an application, instructions to install a new application, instructions to upgrade to a new version of an application, etc.

Responsive thereto, SMO submits (3) a policy verification request to policy engine 320. Policy engine 320 verifies whether the policy semantics are correct and verifies the policy request against what is in the policy engine. For instance, the policy could be to upgrade an NF to a new release, but only during a certain time period in the middle of the night since the upgrade would heavily affect the operation of the network.

Policy engine 320 then returns (4) a policy response to SMO 310 that includes the policies and rules associated with the trigger. The policy response may include the nodes and clusters that are to be updated, the date and time that the update should be performed, etc. In some embodiments, the information contained in a policy response may be received from policy engine 320 without SMO 310 first submitting a policy verification request or receiving a trigger from an external source. Instead, policy engine 320 may independently send (2a) a policy scheduled trigger to SMO 310 to initiate an operation. This may be the case when, for example, a policy defines a scheduled date and time when an operation should be initiated. In such cases, policy engine 320 may automatically send the policy scheduled trigger to SMO 310 in response to receiving the policy and/or at the date and time defined in the policy.

After receiving the policies and/their associated rules, SMO 310 may then build and make (5) a fulfillment API call including the appropriate configuration to repository 340. SMO 310 may build and make the fulfillment API call directly in response to receiving the policies and/their associated rules (e.g., in real or near real time). Additionally, or alternatively, SMO 310 may schedule the API call to occur at a later date and/or time that satisfies one or more criteria defined in a policy or a specific date and time defined in a policy.

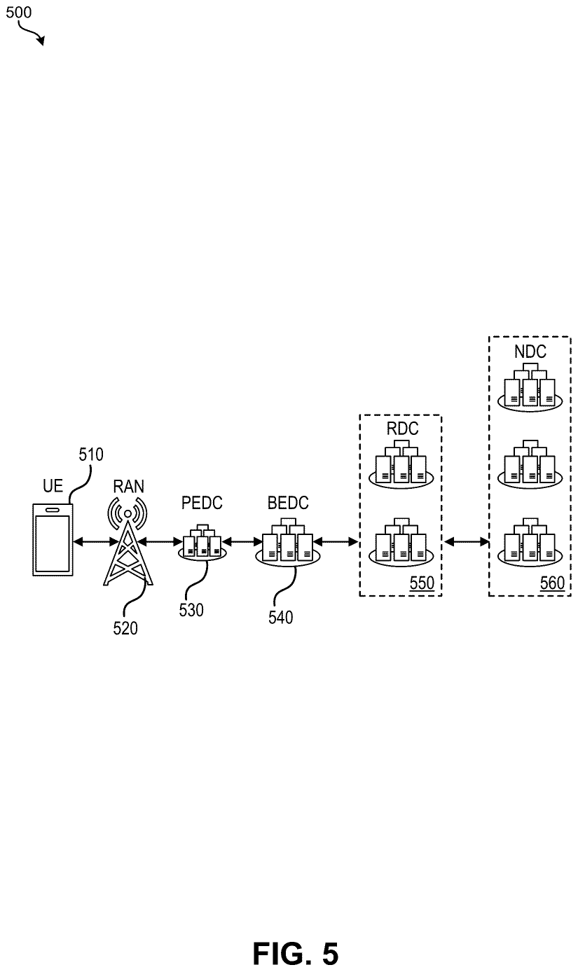

FIG. 5 is an architectural diagram illustrating a telecommunications system 500 that implements software operators for automatic implementation of operations for network applications, according to an embodiment of the present disclosure. UE device 510 (e.g., a mobile phone, a tablet, a laptop computer, a smart watch, etc.) communicates via RAN 520, which sends communications to UE 510. RAN 520 also sends communications from UE 510 into the core carrier network.

In some embodiments, communications are sent to/from RAN 520 via a Performance Edge Data Center (PEDC) 530 to provide lower latency. However, in some embodiments, RAN 520 communicates directly with a BEDC 540 or an RDC of RDCs 550. BEDCs are typically smaller data centers that are proximate to the populations they serve. BEDCs may break out User Plane Function (UPF) for data (UPF-d) packets and provide cloud computing resources and cached content to UE 510, such as providing NF application services for gaming, enterprise applications, etc. In certain embodiments, RAN 520 may include a Local Data Center (LDC, not shown) that hosts one or more DUs in a Fifth Generation (5G) O-RAN architecture. A CU may be located in the LDC or BEDC 540, for example. LDCs, PEDCs, and/or BEDCs may provide Mobile Edge Computing (MEC) services in some embodiments.

The carrier network may provide various NFs and other services. For instance, BEDC 540 may provide cloud computing resources and cached content to mobile device 510, such as providing NF application services for gaming, enterprise applications, etc. RDC 550 may provide core network functions, such as UPF for voice (UPF-v), UPF-d (if not in BEDC 540, for example), Session Management Function (SMF), and Access and Mobility Management Function (AMF) functionality. The SMF includes Packet Data Network Gateway (PGW) Control Plane (PGW-C) functionality. The UPF includes PGW User Data Plane (PGW-U) functionality.

NDC 560 may provide Unified Data Repository (UDR) and user verification services, for example. Other network services that may be provided may include, but are not limited to, Internet Protocol (IP) Multimedia Subsystem (IMS)+Telephone Answering Service (TAS), IP-SM Gateway (i.e., the network functionality that provides the messaging service in the IMS network), Location Management Function (LMF), Gateway Mobile Location Center (GMLC), Enhanced Serving Mobile Location Center (E-SMLC) for former generation wireless networks, Location Retrieval Function (LRF), Home Location Register (HLR), Home Subscriber Server (HSS), UPF+PGW-U, AMF, HSS+UDM, Authentication Server Function (AUSF), SMF+PGW-C, Short Message Service Center (SMSC), Policy Control Function (PCF), MEC, Network Exposure Functions (NEFs) or Common API Framework (CAPIF) for 3GPP northbound APIs, Network Slice Selection Function (NSSF), Non-3GPP InterWorking Function (N3IWF), Network Data Analytics Function (NWDAF), Mediation and Delivery Function (MDF), Service Communication Proxy (SCP), and/or Security Edge Protection Proxy (SEPP) functionality. It should be noted that additional and/or different network functionality may be provided without deviating from the present disclosure. The various functions in these systems may be performed using dockerized clusters in some embodiments.

BEDC 540 may utilize other data centers for NF authentication services. RDCs 550 receive NF authentication requests from BEDC 540. RDCs 550 may help with managing user traffic latency, for instance. However, RDCs 550 may not perform NF authentication in some embodiments. From RDCs 550, NF authentication requests may be sent to NDC 560, which may be located far away from UE 510, RAN 520, PEDC 530, BEDC 540, and RDCs 550.

The NFs and other applications managed by the SMO may be located anywhere in the network, such as in RAN 520, PEDC 530, BEDC 540, RDCs 550, NDC 560, etc. The SMO itself is typically located in RDCs 550 or NDC 560. There may be a single SMO in NDC 560 in some embodiments. In other embodiments, multiple SMOs may be located in RDC(s) 550 and/or NDC 560.

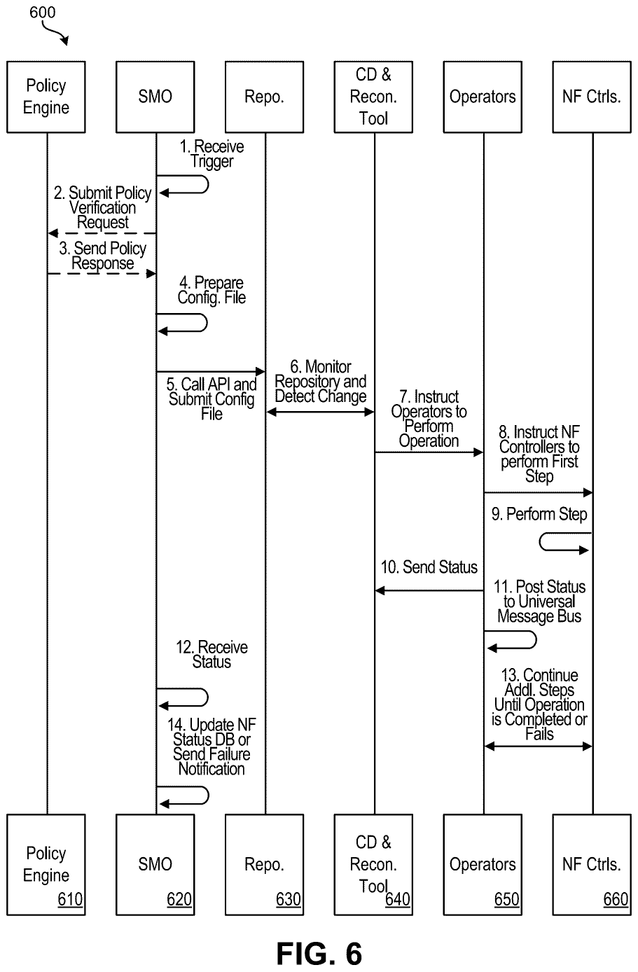

FIG. 6 is a flow diagram illustrating a process 600 for performing operations in a network using an SMO and an operator, according to an embodiment of the present disclosure. The process begins with (1) an SMO 620 receiving a trigger from a pre-production environment, an OSS or a BSS, an operations user, an external automation trigger, or a policy engine 610. In the case that the trigger did not come from policy engine 610, SMO 620 (2) submits a policy verification request to policy engine 610 and (3) policy engine 610 sends a policy response to SMO 620. SMO 620 (4) prepares a configuration file for the operation based on the policy and (5) calls an API to submit the configuration file to a repository 630.

A CD and reconciliation tool 640 (6) monitors repository 630 and detects that the configuration in the configuration file does not match that of at least one cluster in the network. CD and reconciliation tool 640 (7) instructs respective operator(s) 650 to perform the operation and provides operator(s) 650 with the configuration file. Operator(s) 650 (8) instruct respective NF controller(s) 660 of the cluster(s) to perform the first step of the operation. NF controller(s) 660 (9) attempt to perform the step and (10) send a status update to operator(s) 650. Operator(s) 650 (11) post the status update to a universal message bus. SMO 620 (12) receives the status update from the universal message bus and continues to monitor the progress of the operation. Operator(s) 650 and NF controller(s) 660 (13) continue the steps of the operation until it is completed or a step fails. SMO 620 (14) continues monitoring the operation and updates an NF status database if the operation was successful or sends a notification to the appropriate personnel if the operation failed.

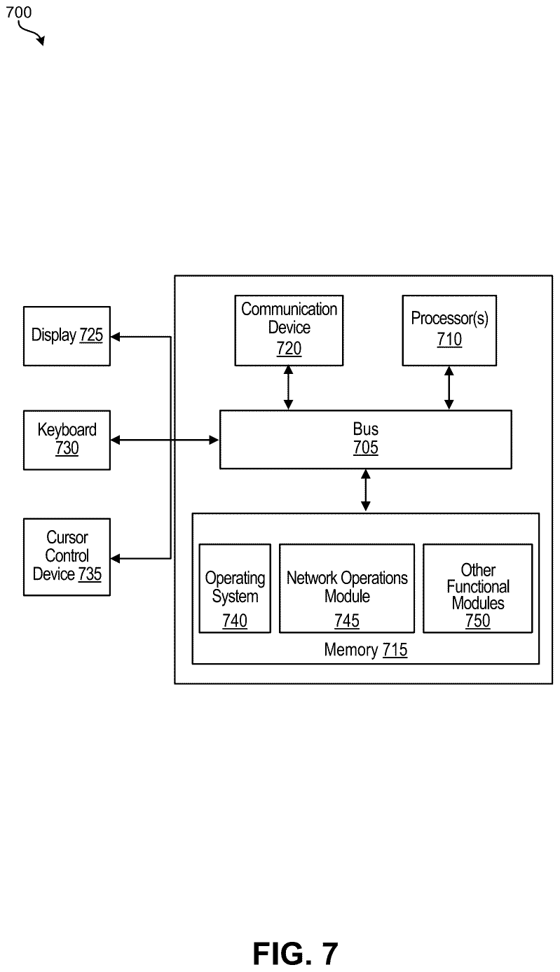

FIG. 7 is an architectural diagram illustrating a computing system 700 configured to participate in a process for performing operations in a network using an SMO and an operator, according to an embodiment of the present disclosure. In some embodiments, computing system 700 may be one or more of the computing systems depicted and/or described herein, such as computing systems of a RAN, computing systems of a network core, computing systems of a business user, an operator, a developer, an OSS or BSS, a database, or any other computing system associated with performing operations in a network without deviating from the disclosure. Computing system 700 includes a bus 705 or other communication mechanism for communicating information, and processor(s) 710 coupled to bus 705 for processing information. Processor(s) 710 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 710 may also have multiple processing cores, and at least some of the cores may be configured to perform specific functions. Multi-parallel processing may be used in some embodiments. In certain embodiments, at least one of processor(s) 710 may be a neuromorphic circuit that includes processing elements that mimic biological neurons. In some embodiments, neuromorphic circuits may not require the typical components of a Von Neumann computing architecture.

Computing system 700 further includes memory 715 for storing information and instructions to be executed by processor(s) 710. Memory 715 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 710 and may include volatile media, non-volatile media, or both. The media may also be removable, non-removable, or both.

Additionally, computing system 700 includes a communication device 720, such as a transceiver, to provide access to a communications network via a wireless and/or wired connection. In some embodiments, communication device 720 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), 5G, New Radio (NR), any combination thereof, and/or any other currently existing or future-implemented communications standard and/or protocol without deviating from the scope of the disclosure. In some embodiments, communication device 720 may include one or more antennas that are singular, arrayed, phased, switched, beamforming, beamsteering, a combination thereof, and or any other antenna configuration without deviating from the scope of the disclosure.

Processor(s) 710 are further coupled via bus 705 to a display 725, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 725 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the disclosure.

A keyboard 730 and a cursor control device 735, such as a computer mouse, a touchpad, etc., are further coupled to bus 705 to enable a user to interface with computing system 700. However, in certain embodiments, a physical keyboard and mouse may not be present, and the user may interact with the device solely through display 725 and/or a touchpad (not shown). Any type and combination of input devices may be used as a matter of design choice. In certain embodiments, no physical input device and/or display is present. For instance, the user may interact with computing system 700 remotely via another computing system in communication therewith, or computing system 700 may operate autonomously.

Memory 715 stores software modules that provide functionality when executed by processor(s) 710. The modules include an operating system 740 for computing system 700. The modules further include a network operations module 745 that is configured to perform all or part of the processes described herein or derivatives thereof. Computing system 700 may include one or more additional functional modules 750 that include additional functionality.

One skilled in the art will appreciate that a “computing system” could be embodied as a server, an embedded computing system, a personal computer, a console, a cell phone, a tablet computing device, a quantum computing system, or any other suitable computing device, or combination of devices without deviating from the scope of the disclosure. Presenting the above-described functions as being performed by a “system” is not intended to limit the scope of the present disclosure in any way, but is intended to provide one example of the many embodiments of the present disclosure. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the disclosure.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the disclosure.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

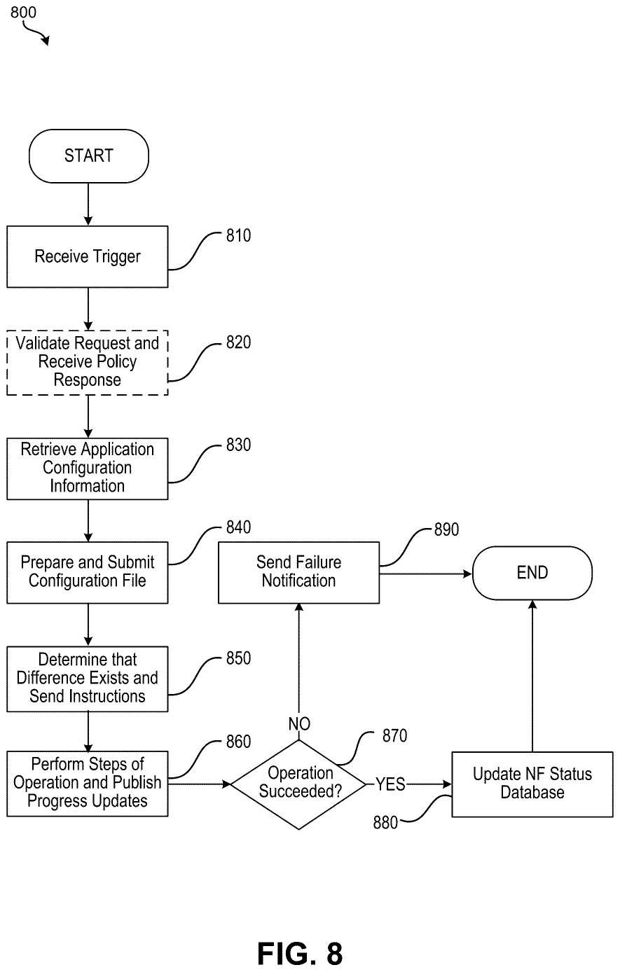

FIG. 8 is a flowchart illustrating a process 800 for performing operations in a network using an SMO and an operator, according to an embodiment of the present disclosure. The process begins with an orchestrator receiving a trigger to perform an operation at 810. In other words, the orchestrator receives a command from a system or a human to perform the operation. The operation may include, but is not limited to, performing instantiation, termination, configuration, re-configuration, backup, recovery, upgrade, rollback, etc. for an application. The trigger may be sent by a pre-production environment, an OSS, a BSS, an operations user, an external automation trigger, a policy engine, etc. In the case that the trigger did not come from the policy engine, orchestrator sends a policy verification request to a policy engine and receives a policy response therefrom at 820. In other words, the policy engine verifies the request associated with the trigger, validates the policy to make sure that the request is legitimate, and provides policies and rules pertaining to the operation to the orchestrator. In some embodiments, the policy response from the policy engine includes which regions the operation applies to, as well as a date and time or the date and a time range during which to perform the operation.

The orchestrator queries an application configuration database that stores configuration information pertaining to one or more applications that the operation pertains to and/or an application custom requirements database that stores custom requirements that one or more nodes and/or at least one cluster have at 830 and uses the information from the query at least in part for the preparation of the configuration file, which is prepared and submitted by the orchestrator to a repository at 840. The CD and reconciliation tool determines that a difference exists between information pertaining to one or more clusters in the configuration file and a current state of the cluster(s) and sends instructions to one or more operators of the cluster(s) to perform the operation at 850. In some embodiments, each NF in the cluster(s) has its own operator.

The operator(s) receive the instructions, perform the steps of the operation via NF controller(s), and publish progress updates to a topic of a universal message bus at 860. The orchestrator is subscribed to this topic and receives these progress updates during the operation. The NF controller(s) are custom controllers that reside in control planes of master nodes, extend functionality of container management systems, and are configured to receive requests from one or more respective operators and perform steps of the operation responsive thereto on one or more worker nodes of the cluster.

If the operation is completed successfully at 870, the orchestrator updates an NF status database with the new configuration for the application and the process ends. However, if a step of the operation failed, the operator(s) inform the orchestrator of this failure via the universal message bus. The orchestrator then sends a failure notification to the appropriate personnel, such as network engineers, technical personnel of the vendor, etc.

The process steps performed in FIGS. 4, 6, and 8 may be performed by computer program(s), encoding instructions for the processor(s) to perform at least part of the process(es) described in FIGS. 4, 6, and 8, in accordance with embodiments of the present disclosure. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 710 of computing system 700 of FIG. 7) to implement all or part of the process steps described in FIGS. 4, 6, and 8, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present disclosure, as generally described and illustrated in the figures herein, may be arranged and designed in a wide variety of different configurations. Thus, the detailed description of the embodiments of the present disclosure, as represented in the attached figures, is not intended to limit the scope of the disclosure as claimed, but is merely representative of selected embodiments of the disclosure.

The features, structures, or characteristics of the disclosure described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present disclosure. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the disclosure can be practiced without one or more of the specific features or advantages of a particular embodiment. In other instances, additional features and advantages may be recognized in certain embodiments that may not be present in all embodiments of the disclosure.

One having ordinary skill in the art will readily understand that the disclosure as discussed above may be practiced with steps in a different order, and/or with hardware elements in configurations which are different than those which are disclosed. Therefore, although the disclosure has been described based upon these preferred embodiments, it would be apparent to those of skill in the art that certain modifications, variations, and alternative constructions would be apparent, while remaining within the spirit and scope of the disclosure. In order to determine the metes and bounds of the disclosure, therefore, reference should be made to the appended claims.

What is claimed is:

1. A cellular network, comprising:
a radio unit configured to support a cell of the cellular network;
a cluster of computing resources in communication with the radio unit, the cluster of computing resources being configured to perform a plurality of network functions that support operations of the radio unit, and comprising:
an operator configured to modify at least one computing resource of the cluster of computing resources based on a specified configuration for the at least one computing resource;
a network management server system in communication with the cluster of computing resources, the network management server system comprising:
a network service orchestrator configured to:
receive a trigger to modify a network function performed by the cluster of computing resources;
generate, in response to receiving the trigger, a desired configuration for the cluster of computing resources that includes the modification to the network function; and
submit the desired configuration for the cluster of computing resources to a configuration repository; and
a reconciliation tool configured to:
determine that a difference exists between the desired configuration for the cluster of computing resources and a current configuration of the cluster of computing resources; and
responsive to determining that the difference exists, transmit the desired configuration to the cluster of computing resources, wherein in response to receiving the desired configuration, the operator modifies a computing resource that corresponds to the network function to be consistent with the desired configuration.

2. The cellular network of claim 1, wherein the network management server system further comprises a policy engine configured to:
transmit one or more policies for modifying the network function provided by the one or more computing resources to the network service orchestrator, wherein the desired configuration is generated based at least in part on the one or more policies received from the policy engine.

3. The cellular network of claim 2, wherein the one or more policies define at least one of a region in which the network function is to be modified and a time range during which the network function is to be modified.

4. The cellular network of claim 1, wherein the operator modifies the computing resource associated with the network function by at least one of: instantiating, terminating, configuring, reconfiguring, backing-up, recovering, upgrading, and rolling back the network function on the computing resource.

5. The cellular network of claim 1, wherein:
the network management server system further comprises a network function configuration database; and
the network service orchestrator is further configured to:
query the network function configuration database for configurations related to the network function in response to receiving the trigger; and
receive, by the network service orchestrator, one or more configurations for the network function from the network function configuration database, wherein the desired configuration is generated based on at least one of the one or more configurations.

6. The cellular network of claim 1, wherein:
the network management server system further comprises a network function requirements database; and
the network service orchestrator is further configured to:
query the network function requirements database for network function requirements related to the one or more computing resources; and
receive one or more network function requirements for the one or more computing resources, wherein the desired configuration is generated based on at least one of the one or more network function requirements.

7. The cellular network of claim 1, wherein:
the cluster is part of a container management system and comprises a control plane and a worker node configured to implement the network function;
the control plane comprises a network function controller that extends functionality of the container management system and manages the implementation of the network function by the worker node; and
the operator modifies the worker node configured to implement the network function by transmitting instructions for modifying the network function to the network function controller.

8. The cellular network of claim 7, wherein the cluster further comprises:
a plurality of worker nodes, each configured to implement a respective network function of a plurality of network functions provided by the cluster; and
a respective operator for each of the plurality of network functions provided by the cluster.

9. The cellular network of claim 1, wherein the network service orchestrator is further configured to:
subscribe to a topic of a universal message bus;
receive, via the topic of the universal message bus, results of modifying the computing resource from the operator;
determine whether the network function provided by the one or more resources was successfully modified based on the results of modifying the computing resource; and
update a network function status database with the results of modifying the network function in response to determining that the network function was successfully modified or transmitting a failure notification via a notification service in response to determining that the network function was unsuccessfully modified.

10. A method of implementing network functions in a cellular network, comprising:
receiving, by a network service orchestrator, a trigger to modify a network function provided by one or more computing resources in the cellular network;
generating, by the network service orchestrator in response to receiving the trigger, a desired configuration for the one or more computing resources;
submitting, by the network service orchestrator, the desired configuration for the one or more computing resources to a configuration repository;
determining, by a reconciliation tool, that a difference exists between the desired configuration for the one or more computing resources and current configurations of the one or more computing resources; and
responsive to determining that the difference exists, transmitting, by the reconciliation tool, the desired configuration to an operator associated with the one or more computing resources, wherein in response to receiving the desired configuration, the operator modifies a computing resource of the one or more computing resources that is associated with the network function to be consistent with the desired configuration.

11. The method of implementing network functions in a cellular network of claim 10, further comprising:
transmitting, by the network service orchestrator, a verification request to a policy engine in response to receiving the trigger to modify the network function provided by the one or more computing resources in the cellular network; and
receiving, by the network service orchestrator, and in response to the verification request, one or more policies for modifying the network function provided by the one or more computing resources from the policy engine, wherein the desired configuration is generated based at least in part on the one or more policies received from the policy engine.

12. The method of implementing network functions in a cellular network of claim 11, wherein the one or more policies for modifying the network function provided by the one or more computing resources define at least one of a region in which the network function is to be modified and a time range during which the network function is to be modified.

13. The method of implementing network functions in a cellular network of claim 10, wherein the trigger to modify the network function is received from a pre-production environment, an Operation Support System (OSS), a Business Support System (BSS), an operations user, or an external automation trigger.

14. The method of implementing network functions in a cellular network of claim 10, wherein the operator modifies the computing resource associated with the network function by at least one of: instantiating, terminating, configuring, reconfiguring, backing-up, recovering, upgrading, and rolling back the network function on the computing resource.

15. The method of implementing network functions in a cellular network of claim 10, further comprising:
querying, by the network service orchestrator, a network function configuration database for configurations related to the network function; and
receiving, by the network service orchestrator, one or more configurations for the network function from the network function configuration database, wherein the desired configuration is generated based on at least one of the one or more configurations.

16. The method of implementing network functions in a cellular network of claim 10, further comprising:
querying, by the network service orchestrator, a network function requirements database for network function requirements related to the one or more computing resources; and
receiving, by the network service orchestrator, one or more network function requirements for the one or more computing resources, wherein the desired configuration is generated based on at least one of the one or more network function requirements.

17. The method of implementing network functions in a cellular network of claim 10, wherein:
the one or more computing resources are part of a cluster of a container management system;
the cluster comprises a control plane and a worker node configured to implement the network function;
the control plane comprises a network function controller that extends functionality of the container management system and manages the implementation of the network function by the worker node; and
the operator modifies the worker node configured to implement the network function by transmitting instructions for modifying the network function to the network function controller.

18. The method of implementing network functions in a cellular network of claim 17, wherein the cluster further comprises:
a plurality of worker nodes, each configured to implement a respective network function of a plurality of network functions provided by the cluster; and
a respective operator for each of the plurality of network functions provided by the cluster.

19. The method of implementing network functions in a cellular network of claim 10, further comprising:
subscribing, by the network service orchestrator, to a topic of a universal message bus;
receiving, by the network service orchestrator via the topic of the universal message bus, results of modifying the computing resource from the operator;
determining, by the network service orchestrator, whether the network function provided by the one or more resources was successfully modified based on the results of modifying the computing resource; and
updating, by the network service orchestrator, a network function status database with the results of modifying the network function in response to determining that the network function was successfully modified or transmitting a failure notification via a notification service in response to determining that the network function was not unsuccessfully modified.

20. A system, comprising:
one or more processors; and
a computer-readable medium comprising instructions that, when executed by the one or more processors, cause the system to:
receive, by a network service orchestrator, a trigger to modify a network function provided by one or more computing resources in a cellular network;
generate, by the network service orchestrator in response to receiving the trigger, a desired configuration for the one or more computing resources;
submit, by the network service orchestrator, the desired configuration for the one or more computing resources to a configuration repository;
determine, by a reconciliation tool, that a difference exists between the desired configuration for the one or more computing resources and current configurations of the one or more computing resources; and
responsive to determining that the difference exists, transmit, by the reconciliation tool, the desired configuration to an operator associated with the one or more computing resources, wherein in response to receiving the desired configuration, the operator modifies a computing resource of the one or more computing resources that is associated with the network function to be consistent with the desired configuration.
